(19) United States
(12) Patent Application Publication
(10) Pub. No.: US 2019/0255386 A1
(43) Pub. Date: Aug. 22, 2019

(54) INTERACTIVE EXERCISE ACTIVITY SYSTEM AND METHODS

(71) Applicant: Dimensional Innovations, Inc., Overland Park, KS (US)

(72) Inventors: Tucker D. Trotter, Leawood, KS (US); Nathan R. Borozinski, Olathe, KS (US); Brandon D. Wood, Kansas City, MO (US); Lindsey L. Weber, Kansas City, KS (US); Benjamin T. Hansen, Shawnee, KS (US); Christopher D. Walker, Leawood, KS (US); Chris M. Riebschlager, Kansas City, MO (US); Jonathan D. Hillen, Olathe, KS (US); Emilio J. Servignon, Kansas City, MO (US)

(21) Appl. No.: 16/280,679

(22) Filed: Feb. 20, 2019

Related U.S. Application Data
(60) Provisional application No. 62/632,857, filed on Feb. 20, 2018.

(51) Int. Cl. A63B 24/00

(52) U.S. Cl. CPC A63B 24/0084; A63B 24/0087; G06F 3/0488; A63B 24/0062; A63B 24/0006

(57) ABSTRACT

An Interactive Exercise Activity System and Methods configured to provide environmental feedback stimulation based on group and individual performance data. The system and methods provide for the analysis of group performance data; whereby a reactive output is generated and configured to control environmental stimuli such as screen visualizations, ambient and equipment lighting, audio systems, and ventilation systems. The system and methods further utilize a gamification system which allows distinct exercise groups to compete against each other, whether on-site or remotely. The system and methods further provides for a transmission of a summary of an individual or group performance data at the completion of a workout session. An additional embodiment of the system and methods includes providing environmental stimulation to a user based on individual performance metrics.

### CROSS-REFERENCE TO RELATED APPLICATIONS

This present non-provisional patent application claims priority to U.S. Provisional Patent Application No. 62/632,857, filed Feb. 20, 2018, titled “INTERACTIVE EXERCISE ACTIVITY SYSTEM”, which is hereby incorporated by reference in its entirety.

### TECHNICAL FIELD

This invention relates generally to an interactive exercise system and more particularly, but not exclusively, to a system for providing individual and group performance feedback using environmental stimulations responsive to biometric and performance data.

### BACKGROUND

User engagement and feedback has become increasingly important in the field of group exercise, especially on stationary equipment that lacks environmental stimuli and competition. When exercise machines are stationary, it is typically incumbent upon the equipment manufacturer to provide equipment features that engage the user to provide performance feedback and motivation. Such engagement typically includes limited feedback of individual performance statistics associated with the workout session. Isolation and lack of feedback during exercise deters user participation and leads to the abandonment of exercise goals.

### SUMMARY

The disclosed subject matter is directed towards an interactive exercise activity system responsive to performance data associated with individual and/or group activity. In an embodiment, the system having features of the present invention comprises a pair of exercise groups; wherein each exercise group comprising at least one exercise device; and a system analyzer configured to: collect performance data associated with the at least one exercise device; analyze the performance data collectively associated with each exercise group; and provide at least one reactive output associated with each exercise group based on the analysis of the performance data. In another embodiment, the interactive exercise activity system comprises a screen visualization associated with the at least one reactive output. In another embodiment, the screen visualization comprising one or more of: a dynamic environmental display; and a leaderboard comprising one or more group performance metrics associated with the analysis of the performance data.

In another embodiment of the system, the dynamic environmental display includes one or more of: a plurality of reactive lights; an abstract visualization; a simulated water surface; a simulated road environment; a simulated trail environment; and a simulated spatial environment.

In an embodiment of the system, the one or more group performance metrics comprises one or more of: overall leader; leader within each of the pair of groups; leading group of the pair of groups; distance; speed; stroke rate; revolutions per minute; elevation gain; vertical oscillation; split time; 1-mile split time; total time; weight; watts; cadence; heart rate; and calories burned.

In another embodiment, the system comprises a plurality of system module responsive to the at least one reactive output of the system analyzer. The plurality of system module comprise one or more of: a tactile feedback module; a display module; an audio module; a light module; and a ventilation module. In another embodiment, the tactile feedback module controls a feedback device being in tactile or visual communication with a user of the at least one exercise device. In yet another embodiment, the display module is configured to project the screen visualization onto a screen, or wall, using at least one video projector. In another embodiment, a light module is provided to produce a dynamic lighting environment around the user. In another embodiment, the audio module is configured to receive the at least one responsive output from the system analyzer and transmit an audio signal associated with the at least one reactive output to an audio receiver. The audio receiver configured to receive the audio signal from the audio module and produce a sound field through at least one external speaker; whereby the sound field is associated with the at least one reactive output. In another embodiment, the ventilation module is configured to control a ventilation system in order to provide tactile feedback to the user associated with the at least one reactive output.

In another embodiment, the exercise devices further comprising: a device module configured to communicate with the system analyzer; a device CPU configured to communicate with the device module; a set of device data accessible by the device CPU; at least one device sensor configured to communicate with the device CPU and device module; the at least one device sensor configured to measure performance data associated with the operation of the exercise device; wherein the at least one device sensor configured to transmit performance data to the device module; an indicator responsive to the performance data; and a touch screen interface operably connected to the device module. In yet another embodiment, the indicator comprising a light source.

In an embodiment, at least one user sensor is configured for wired or wireless communication with the device module. The at least one user sensor includes one or more of: a heart rate monitor, an oxygen monitor, and a pedometer.

In another embodiment, the system includes a gamification display area wherein group performance metrics of a group or individual may be compared and visualized to create a competitive environment between groups and/or individuals.

In another embodiment, a system having features of the present invention comprises an exercise machine configured to continuously monitor a performance metric associated with the use of the exercise machine; and an indicator responsive to the performance metric; the indicator configured to display a first state indicator if the performance metric is less than a first predetermined value; the indicator configured to display a second state indicator if the performance metric is above the first predetermined value.

In another embodiment, wherein the indicator is a light source configured to display the second state indicator if the performance metric is below a second predetermined value; and wherein the light source is configured to display a third state indicator if the performance metric is greater than the second predetermined value.

In another embodiment, a system having features of the present invention comprises a first group of exercise machines; a second group of exercise machines; a system analyzer configured to: collect performance data associated with the first group of exercise machines and the second group of exercise machines; determine one or more first group performance metrics associated with the performance data of the first group of exercise machines; and determine one or more second group performance metrics associated with the performance data of the second group of exercise machines; a dynamic environmental display responsive to the one or more first group performance metrics and the one or more second group performance metrics; and a leaderboard comparing at least one of the one or more first group performance metrics against at least one of the one or more second group performance metrics.

In another embodiment, the system having features of the present invention includes an exercise machine configured to continuously monitor a performance metric associated with the use of the machine; and an indicator responsive to the performance metric; the indicator configured to display a first state indicator if the performance metric is less than a first predetermined value; the indicator configured to display a second state indicator if the performance metric is above the first predetermined value. In another embodiment of the system, the indicator is a light source configured to display the second state indicator if the performance metric is below a second predetermined value; and wherein the light source is configured to display a third state indicator if the performance metric is greater than the second predetermined value.

In yet another embodiment, an exercise environment comprises: an exercise room comprising a pair of exercise groups; wherein each exercise groups comprising at least one exercise device; the at least one exercise device comprising: a device a device module configured to communicate with a device CPU associated with the at least one exercise device; and a touch screen interface configured to communicate with the device module; a system analyzer configured to: collect performance data from the device module associated with the at least one stationary rower; analyze the performance data collectively associated with each exercise group; and provide at least one reactive output associated with each exercise group based on the analysis of the performance data; and a screen visualization associated with the at least one reactive output; wherein the screen visualization comprising one or more of: a simulated special environment; and a leaderboard comprising one or more group performance metrics associated with the analysis of the performance data. In another embodiment of the exercise environment, the exercise device includes a stationary rower; and the simulated special environment includes a simulated water surface.

An embodiment of a method of providing an interactive exercise system includes providing a providing a pair of exercise groups; wherein each pair of exercise groups comprising at least one exercise device; collecting performance data associated with the at least one exercise device; analyzing the performance data collectively associated with each pair of exercise groups; determining one or more first group performance metrics associated with the collective analysis of the performance data; and generating at least one reactive output associated with the one or more first group performance metrics. The method may include the steps of displaying a screen visualization associated with the at least one reactive output; and displaying a leaderboard associated with the one or more group performance metrics. In another embodiment of the method, the screen visualization includes a simulated special environment.

Another embodiment of a method of providing an interactive exercise system includes providing an exercise machine configured to detect a performance metric; monitoring the performance metric; and controlling an environmental stimulation associated with the performance metric. In some embodiments of the method, the exercise machine includes a rowing machine, and the performance metric includes a stroke rate. In another embodiment of the method, the environmental stimulation includes one or more of a light source; a ventilation source; and a sound source. In yet another embodiment of the method, the light source is configured to illuminate a water tub of the rowing machine.

An objective of the interactive exercise activity system and methods is to provide an improved workout environment. Another objective of the interactive exercise activity system and methods is to provide an improved interactive exercise system.

### BRIEF DESCRIPTION OF THE DRAWINGS

The drawings constitute a part of this specification and include exemplary embodiments of the disclosed subject matter and illustrate various features thereof.

FIG. 1 is a schematic view of an embodiment of the interactive exercise activity system.

FIG. 2 is a schematic view of an embodiment of the interactive exercise activity system

FIG. 3 illustrates an embodiment of a screen visualization.

FIG. 4 illustrates an embodiment of a screen visualization.

FIG. 5A illustrates an embodiment of a screen visualization.

FIG. 5B illustrates an embodiment of a screen visualization.

FIG. 6A illustrates an embodiment of a screen visualization including embodiments of a display of performance metrics, a leaderboard, and a gamification system.

FIG. 6B illustrates an embodiment of a screen visualization including embodiments of a display of performance metrics, a leaderboard, and a gamification system.

FIG. 6C illustrates an embodiment of a screen visualization including embodiments of group performance statics and a leaderboard.

FIG. 7A illustrates an embodiment an information display area.

FIG. 7B illustrates an embodiment an information display area.

FIG. 8A illustrates an embodiment of a touch screen interface for a user.

FIG. 8B illustrates an embodiment of a touch screen interface for a user.

FIG. 8C illustrates an embodiment of a touch screen interface for a user.

FIG. 9A is an embodiment of a summary e-mail.

FIG. 9B is an embodiment of a webpage.

FIG. 10 illustrates an embodiment of a touch screen interface for an instructor.

FIG. 11 illustrates an embodiment of a touch screen interface for an instructor.

FIG. 12 is a schematic view of an embodiment of the disclosed subject matter.

FIG. 13 is a schematic view of an embodiment of the disclosed subject matter.

FIG. 14 is a flow chart of a method of use of an embodiment of the disclosed subject matter.

FIG. 15 is a flow chart of a method of use of an embodiment of the disclosed subject matter.

FIG. 16 is a flow chart of a method of use of an embodiment of the disclosed subject matter.

FIG. 17 is a flow chart of a method of use of an embodiment of the disclosed subject matter.

### DETAILED DESCRIPTION

Detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

The detailed description includes the disclosure of numerical ranges. Numerical ranges should be construed to provide literal support for claim limitations reciting only the upper vale of a numerical range, and provide literal support for claim limitations reciting only the lower value of a numerical range.

Although the invention has been disclosed with reference to various particular embodiments, it is understood that equivalents may be employed and substitutions made herein without departing from the scope of the invention as recited in the claims.

It is to be understood that while certain aspects of the disclosed subject matter have been shown and described, the disclosed subject matter is not limited thereto and encompasses various other embodiments and aspects.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

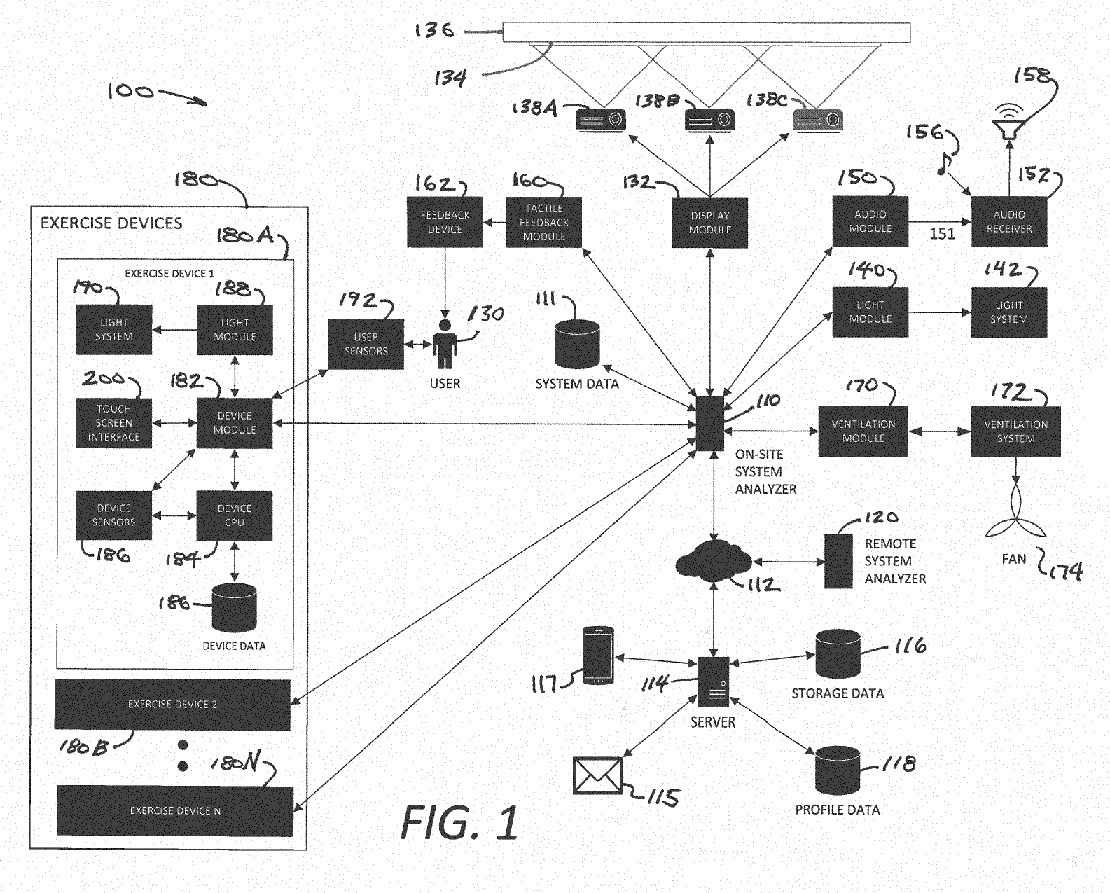

Referring to FIG. 1, illustrates one embodiment of the basic environment in which the interactive exercise activity system 100 operates. This environment includes at least one onsite system analyzer 110 and at least one server 114 in wired or wireless communication with the onsite system analyzer 112 via a communication network 112. The communication network 112 comprises existing Internet infrastructure or custom infrastructure. The server 114 comprises storage data 116 for the system 100, and profile data 118 associated with each user 130 of the system 100. The server 114 uses a cloud computer model or architecture to transmit and/or process data between system analyzers located at different sites. In a preferred embodiment of the disclosed subject matter, the server 114 is in wired or wireless communication with the onsite system analyzer 110 and at least one remote system analyzer 120. In other embodiments, the system 100 is expanded to comprise a plurality of system analyzers located at any number of remote sites, each of the plurality of system analyzers configured to communicate with the server 114 via the communication network 112.

The server 114 is further configured to create, store and transmit a workout summary to a user 130 at the completion of a workout session. In embodiments, the workout summary is transmitted to an e-mail account 115 and/or to a remote application, such as a mobile application 117. In an embodiment, the workout summary comprises workout session information (e.g., date, time, location, instructor, class name), equipment information (e.g., make and model of exercise equipment), group information (e.g, associated users and groups involved in workout session), and performance information (e.g, individual and group performance metrics, results of competition between individuals and groups).

In an embodiment, the onsite system analyzer 110 comprises a personal computer configured to communicate with one of more of a display module 132, a light module 140, an audio module 150, and a tactile feedback module 160 based on at least one reactive output from the system analyzer 110; wherein the user 130 is provided feedback on individual and group performance metrics. The onsite system analyzer 110 comprises a system data storage 111 configured for the storage and retrieval of system data associated with system 100. In an embodiment of the disclosed subject matter, the onsite system analyzer 110 is configured for wireless communication with one of more of the display module 132, light module 140, audio module 150, and tactile feedback module 160.

The display module 132 configured to produce a dynamic environmental display 134, responsive to the at least one reactive output of the onsite system analyzer 110, via at least one projector 138A-C onto a display area 136. The display area 136 positioned in the line of sight of the user 130.

The light module 140 configured to produce a dynamic lighting environment via a light system 142. The light module 140 being responsive to the at least one reactive output of the onsite system analyzer 110. The light system comprising at least one of ambient ceiling lights; ambient floor lights; and ambient equipment lights; whereby the light system changes color or intensity based on the at least one reactive output.

The audio module 150 configured to produce a dynamic sound environment around the exercise devices 180. The audio module 150 is configured to receive the at least one responsive output from the system analyzer 110 and transmit an audio signal 151 associated with the at least one reactive output to an audio receiver 152. The audio receiver 152 configured to receive the audio signal 151 from the audio module 150 and produce a sound field through at least one external speaker 158. The audio receiver 152 further configured to receive at least one external audio signal 156, such as, by way of example, a music file. The audio signal 151 may be played alone, or in combination with the at least one audio signal 156, through the at least one external speaker 158; wherein the at least one external speaker 158 is positioned within a field of hearing of the user 130; whereby the user 130 receives audio feedback from the at least one responsive output of the onsite system analyzer 110.

The tactile feedback module 160, connected to the onsite system analyzer 110, is configured to receive the at least one reactive output from the system analyzer 110 and communicate the at least one reactive output to the user 130 via a feedback device 162 configured to create a tactile, visual or audio stimulation of the user 130; whereby through use of the feedback device 162, the user 130 receives feedback from the at least one reactive output.

The ventilation module 170, connected to the onsite system analyzer 110, is configured to receive the at least one reactive output from the system analyzer 110 and control a ventilation system 172 based on the reactive output. In an embodiment, the ventilation system 172 comprises at least one fan 174 responsive to the at least one reactive output; whereby a user may experience increased or decreased ventilation while using an exercise device based on the at least one reactive output. For example, the speed of the at least one fan 174 may be proportional to performance metrics of a group of exercise devices 180 as expressed by the at least one reactive output. In another embodiment, the speed of the at least one fan 174 may be associated with predetermined threshold values of a group performance metric (e.g., an average stroke rate). For example, the at least one fan 174 is configured to a first fan speed (or no speed) if a group performance metric does not meet a low threshold value; the speed of the at least one fan 174 is configured to a second fan speed if the group performance metric is between the low threshold value and a high threshold value; and the speed of the at least one fan 174 is configured to at third speed if the group performance metric is above the a high threshold value; whereby a user 130 receives tactile feedback from the at least one fan based on the at least one reactive output.

The onsite system analyzer 110 is configured to receive performance data from exercise devices 180. In an embodiment of the disclosed subject matter, the onsite system analyzer 110 is configured to receive individual performance data from each of a plurality of exercise devices 180A-N. The exercise devices 180, each comprising: a device module 182 configured to communicate with the onsite system analyzer 110; a device CPU 184 configured to communicate with the device module 182; a set of device data 186 accessible by the device CPU 184; at least one device sensor 186 configured to communicate with the exercise device 180; the at least one device sensor 186 configured to measure performance data associated with the operation of the exercise device; wherein the at least one device sensors 186 configured to transmit performance data to the device module 182 and the device CPU 184; a light module 188 connected to the device module 182; whereby a light system 190 may be controlled by the performance data received by the device sensors 186 and processed by the device module 182; and a touch screen interface 200 operably connected to the device module 182.

In an embodiment of the disclosed subject matter, wherein the performance data associated with the operation of the exercise devices 180 comprises one or more of: session time; distance; speed; stroke length; stroke speed; strokes; revolutions; revolutions per minute; pedal speed; elevation gain; vertical oscillation; inclination; steps; step height; step speed; step length; weight; resistance; repetitions; cadence; watts; oxygen consumption; heart rate; and calories burned.

In an embodiment of the disclosed subject matter, at least one user sensor 192 configured for wired or wireless communication with the device module 182. The at least one user sensor 192 comprises one or more of: a heart rate monitor, an oxygen monitor, and a pedometer.

In an embodiment of the disclosed subject matter, exercise devices 180 comprise one or more of: rowing machines; spin bicycles; cross trainers; elliptical; treadmills; climbing wall treadmills; stair climbers and resistance trainers.

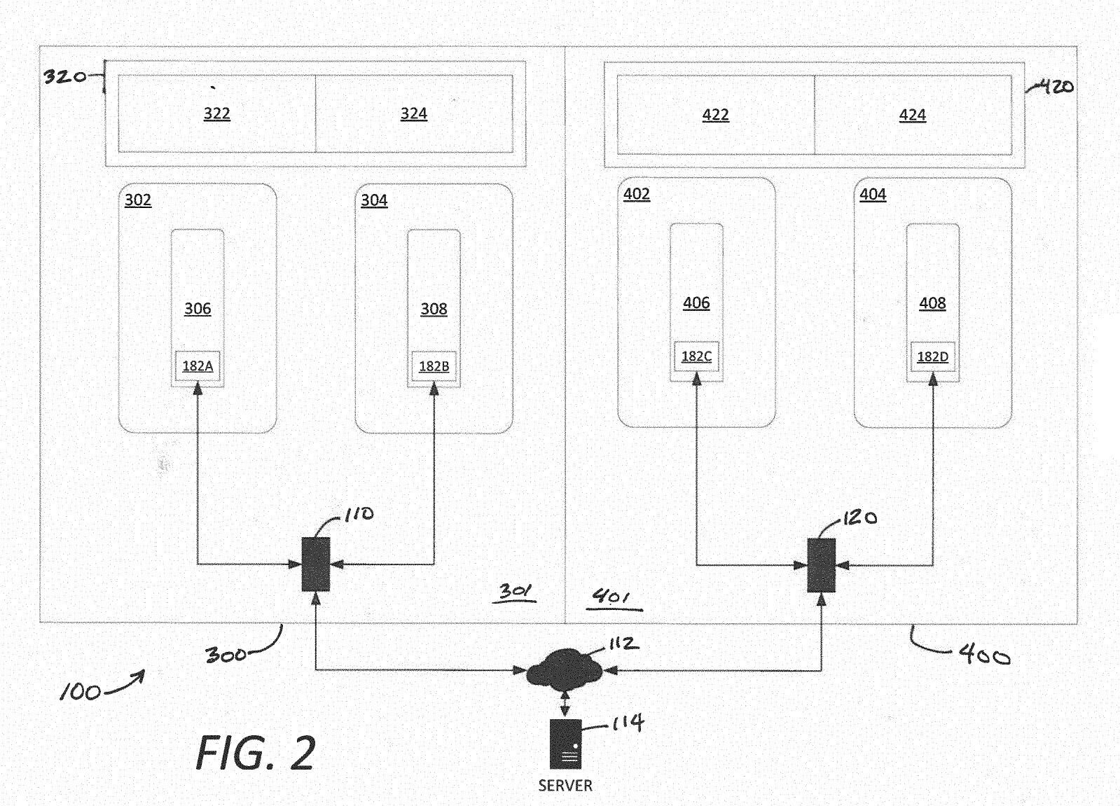

Referring to FIG. 2, a first site 300 is illustrated as comprising a first exercise group 302 and a second exercise group 304; wherein the first exercise group 302 comprises at least one first exercise device 306; and wherein the second exercise group 304 comprises at least one second exercise device 308. In a similar arrangement of the first site 300, a second site 400 is illustrated as comprising a third exercise group 402 and a fourth exercise group 404; wherein the third exercise group 402 comprises at least one third exercise device 406; and wherein the fourth exercise group 404 comprises at least one fourth exercise device 408. In an embodiment of the disclosed subject matter, the first site 300 comprises a first exercise room 301 wherein the first exercise group 302 and the second exercise group 304 are disposed. Similarly, the second site 400 comprises a second exercise room 401 wherein the third exercise group 402 and the fourth exercise group 404 are disposed.

The exercise groups 302, 304, 402, 404 comprise any combination of exercise devices 180. The device modules 182A,182B of each exercise device 306,308 associated with the first site 300 are connected to the onsite system analyzer 110. In a similar fashion, the device modules 182C,182D of each exercise device 406,408 associated with the second site 400 are connected to the remote system analyzer 120. The system analyzers 110,120 are connected to a server 114 via a communication network 112. In another embodiment of the disclosed subject matter, a plurality of sites comprising additional groupings of exercise devices may be similarly connected to server 114, creating a system wherein the performance data of all connected exercise devices is communicated to server 114.

A first screen 320 is disposed before the line of sight of the first exercise group 302 and the second exercise group 304. The first screen 320 comprises a first screen area 322 adjacent to a second screen area 324; wherein the first screen area 322 is disposed before the line of sight of the first exercise group 302, and the second screen area 324 is disposed before the line of sight of the second exercise group 304. The first screen 320 comprises additional distinct screen areas if the first site 300 comprises additional exercise groups. In a similar manner, a second screen 420 is disposed before the line of sight of the third exercise group 402 and the fourth exercise group 404. The second screen 420 comprises a third screen area 422 adjacent to a fourth screen area 424; wherein the third screen area 422 is disposed before the line of sight of the third exercise group 402, and the fourth screen area 424 is disposed before the line of sight of the fourth exercise group 242. The second screen 420 comprises additional distinct screen areas if the second site 400 comprises additional exercise groups.

The on-site system analyzer 110 associated with the first and second exercise groups 302,304 configured to: collect performance data associated with the at least one first exercise device 306 and the at least one second exercise device 308; analyze the performance data collectively associated with each of the first exercise group 302 and the second exercise group 304; and provide at least one reactive output associated with each of the first exercise group 302 and the second exercise group 304. The offsite system analyzer 120 associated with the third and fourth exercise groups 402,404 configured to: collect performance data associated with the at least one third exercise device 406 and the at least one fourth exercise device 408; analyze the performance data collectively associated with each of the third exercise group 402 and the fourth exercise group 404; and provide at least one reactive output associated with each of the first exercise group 302 and the second exercise group 304.

For each exercise group 302,304,402,404, the system analyzers 110, 120 configured to determine one or more group performance metrics associated with the corresponding group performance based on the performance data of each grouping of exercise machines. For example, if the first exercise group 302 comprises three rowing machines, the reactive output may be associated with the average stroke rate of the three rowing machines and displayed to the first exercise group 302 on the first screen area 322 via the display module 132 (as shown in FIG. 1). Additionally, the reactive output associated with the first exercise group 302 may be utilized by one or more of the tactile feedback module 160, audio module 150, light module 140, and ventilation module 170 to provide group performance feedback to the first exercise group 302. In a similar way, group performance feedback may be provided to each of the second, third and fourth exercise groups 304,402,404, each based on the group performance data of the associated group.

In an embodiment of the disclosed subject matter the one or more group performance metrics comprises one or more of: overall leader; leader within each of the exercise groups; leading group of the exercise groups; distance; speed; stroke rate; revolutions per minute; elevation gain; vertical oscillation; split time; 1-mile split time; total time; weight; watts; cadence; heart rate; and calories burned.

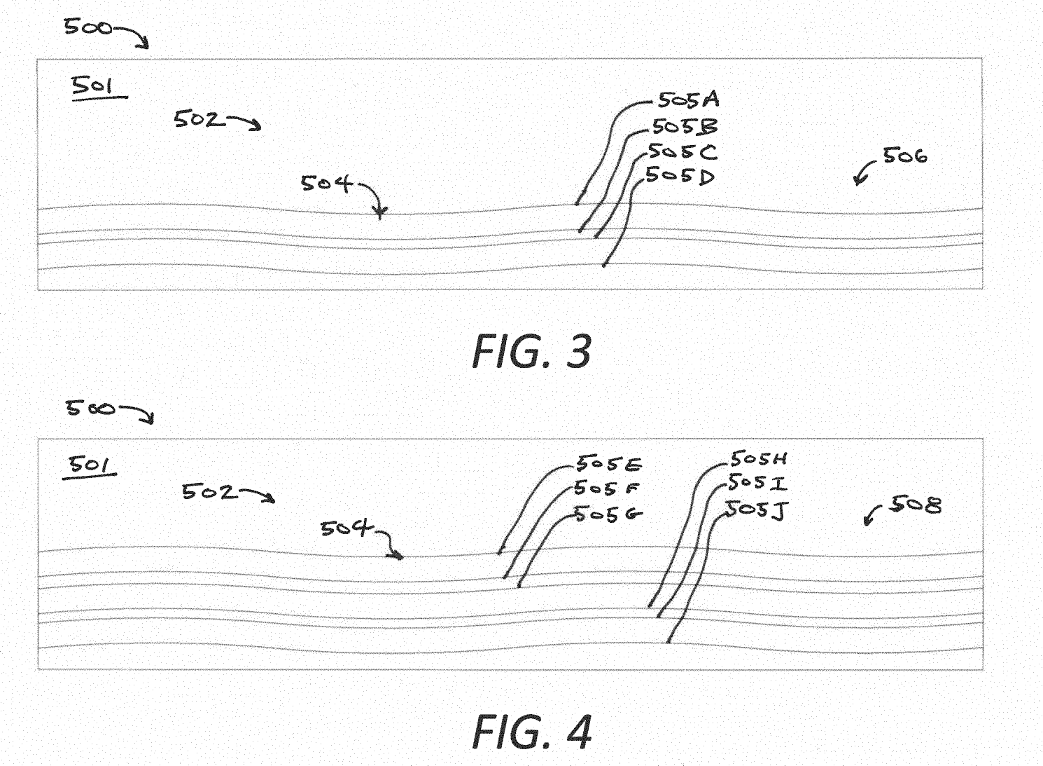

Referring to FIGS. 3-4, a screen visualization 500 is displayed on a screen 501. The screen visualization 500 comprises a dynamic environmental display 502 associated with the at least one reactive output. A simulated water surface 504 is illustrated with a plurality of dynamic waves 505A-J configured to respond to the at least one reactive output. The first set of dynamic waves 505A-D in FIG. 3 move from a first wave position 506 as illustrated in FIG. 3 to a second wave position 508 as illustrated by a second plurality of dynamic waves 505E-J in FIG. 4.

In addition to the simulated water surface 504, in other embodiments of the disclosed subject matter, the dynamic environmental display 502 comprises one or more of: a plurality of reactive lights; an abstract visualization; a simulated road environment; a simulated trail environment; and a simulated special environment.

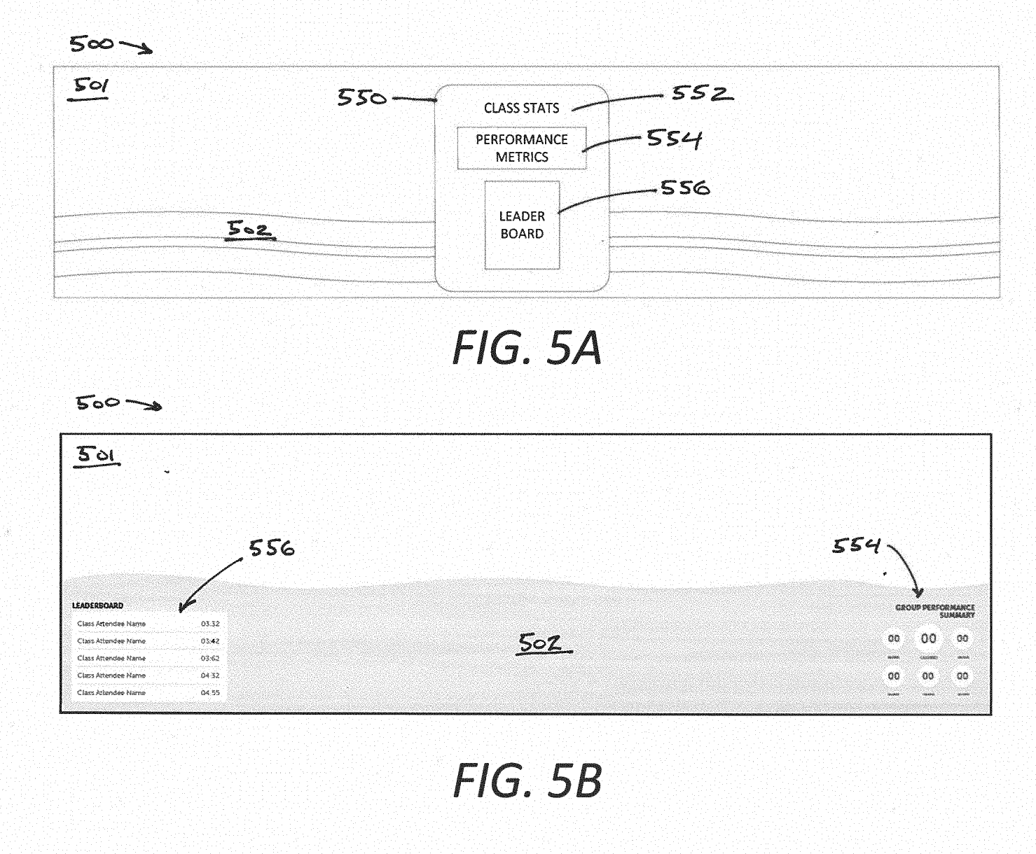

Referring to FIG. 5A, in addition to the dynamic environmental display 502, in an embodiment, the screen visualization 500 comprises an information display area 550 centrally displayed on the screen 501, the information display area 550 comprising: a group ID 552; a group performance information area 554; and a leaderboard area 556.

Referring to FIG. 5B, an embodiment of the screen visualization 500 comprises: an dynamic environmental display 502 configured to fill screen 501; a leaderboard area 556 displayed at the lower left side of screen 501, and a group performance information area 554 displayed at the lower right side of screen 501. This embodiment allows the user to focus on the dynamic environmental display 502 since it is centrally positioned before the user.

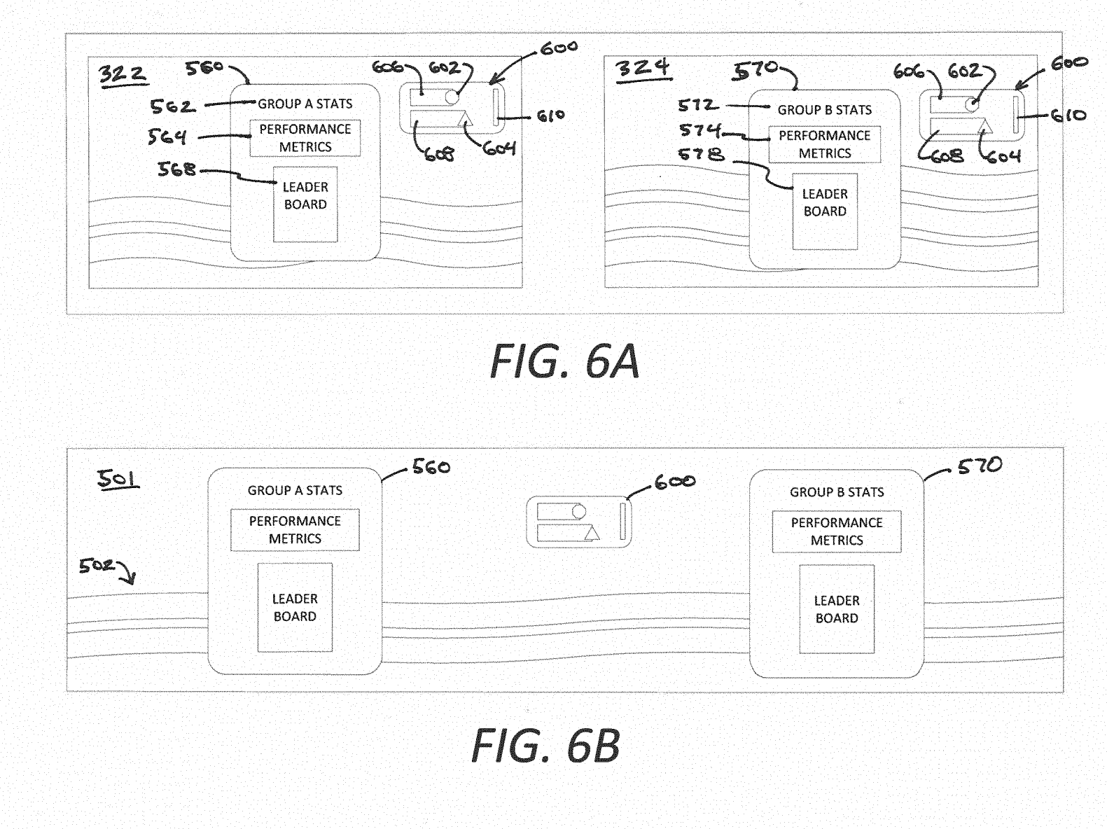

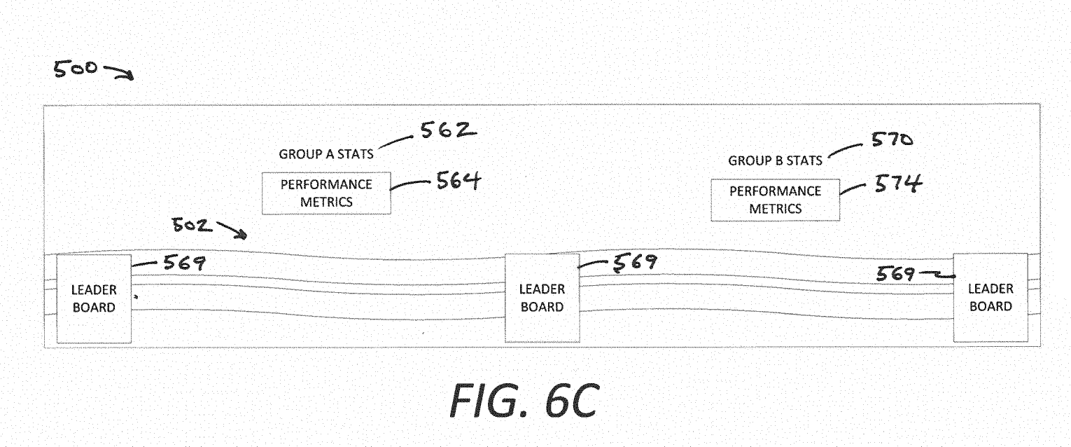

Referring to FIG. 6A, the first screen area 322 is displayed adjacent to the second screen area 324. A first informational display area 560 associated with the first exercise group 302 is displayed in the first screen area 322; while a second informational display 570 associated with the second exercise group 304 is displayed in the second screen area 324. The first informational display area 560 comprising: a first group ID 562; a first group performance information area 564; and a first leaderboard area 568. Similarly, the second informational display area 570 comprising: a second group ID 572; a second group performance information area 574; and a second leaderboard area 578. The first group performance information area 564 and the second group performance information area 574 each comprising performance metrics associated with the performance data of the first exercise group 302 and second exercise group 304 respectively. A gamification display area 600 is displayed on the first and second screen areas 322,324; wherein a group performance metric of the each group may be compared and visualized to create a competitive environment between the groups. The gamification display area 600 comprises a first icon 602 representing a first group; a second icon 604 representing a second group; a first progress indicator 606 associated with the first group; a second progress indicator 608 associated with the second group; a goal indicator 610 associated completion of the competition. In an embodiment, the icons 602,604 move in accordance with the progress of their associated group towards a performance goal represented by the goal indicator 610. In an embodiment, the performance goal comprises any variety of exercise goals desired for competition; for example, total distance, total elevation gain, total calories burned.

Referring to FIG. 6B, in an embodiment of the disclosed subject matter, a dynamic environmental display 502 responsive to the performance data collectively associated with a first and second exercise group is displayed on screen 501; wherein a first information display area 560 is located in the line of sight of the first exercise group; a second informational display area 570 is located in the line of sight of the second exercise group; and a gamification display area 600 is disposed between the first information display area 560 and the second information display area 570.

Referring to FIG. 6C, in an embodiment of the disclosed subject matter, a screen visualization 500 comprises: a dynamic environmental display 502 responsive to the performance data collectively associated with a first and second exercise group is displayed on screen 501; a first group ID 562 and a first group performance information area 564 are collective displayed in a first the line of sight of the first exercise group; wherein a second group ID 570 and a second group performance information area 574 are collectively displayed in a second line of sight of the second exercise group; and a plurality of leaderboards 569 are displayed between the first group ID 562 and the second group ID 564.

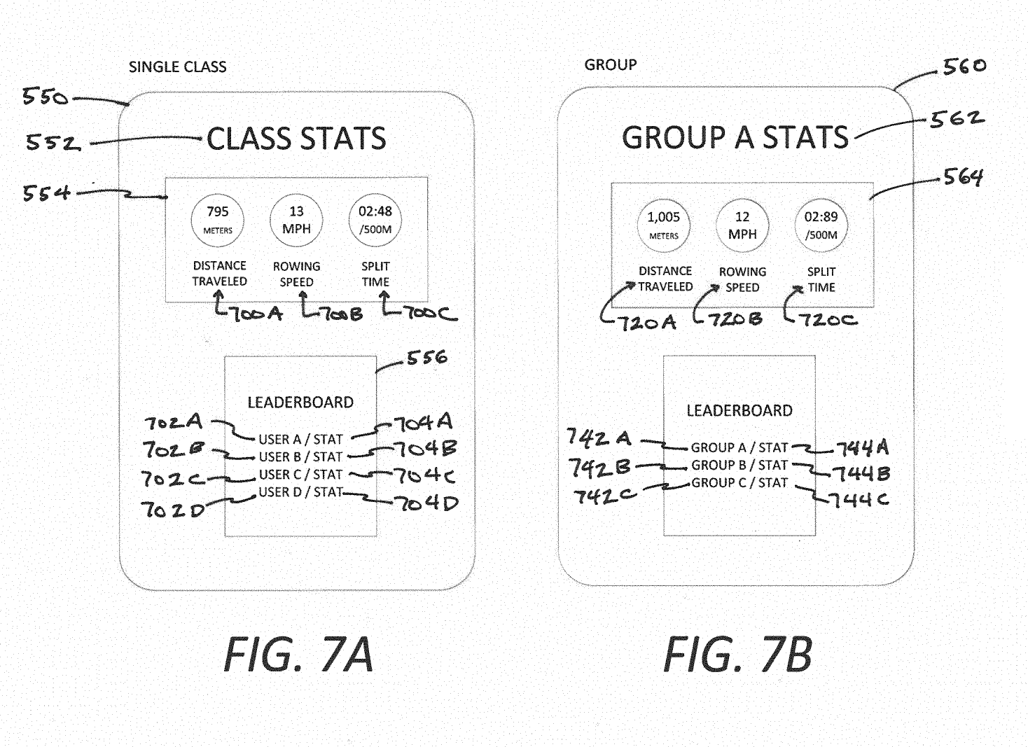

FIG. 7A provides a schematic layout of the information display area 550 as shown in FIG. 5A for a single workout class. The group ID 552 is centrally displayed over the performance information area 554. The performance information area 554 comprises a plurality of class performance metrics 700A-C associated with the collective performance data of the class; for example, where the exercise devices comprise rowing machines, the class performance metrics 700A-C comprise a distance traveled, a rowing speed and a split time. In another embodiment, where the exercise devices comprise treadmills, the class performance metrics 700A-C comprise a distance traveled, a pace, and a split time. The information display area 550 further comprises a leaderboard 556 comprising a visual ranking of user names 702A-D based on a performance metric, such as stroke speed, split time, distance traveled, etc. The performance metric 704A-D is displayed next to the user name 702A-D. It is appreciated that the leaderboard 556 may cycle through a ranking of users based on different performance data; for example, the leaderboard 556 may begin by ranking users by stroke speed, then change to distance traveled, then change to split times, and then repeat.

FIG. 7B provides a schematic layout of the first information display area 560 as shown in FIGS. 6A-C for a group among a plurality of competing exercise groups. The group ID 562 is centrally displayed over the performance information area 564. The performance information area 564 comprises a plurality of group performance metrics 720A-C associated with the collective performance data of the group; for example, where the exercise devices comprise rowing machines, the group performance metrics 720A-C comprise a total distance traveled of the group, an average rowing speed of the group and an average split time of the group. In another embodiment, where the exercise devices comprise treadmills, the group performance metrics 720A-C comprise a total distance traveled by the group, an average pace of the group, and an average split time of the group. The information display area 560 further comprises a group leaderboard 740 comprising a visual ranking of group names 742A-C based on a group performance metric, such as an average stroke speed of the group, an average split time of the group, a total distance traveled by group, etc. The group performance metric 744A-C is displayed next to the group name 742A-C. It is appreciated that the group leaderboard 740 may cycle through a ranking of groups 742A-C based on different performance data; for example, the group leaderboard 740 may begin by ranking groups by an average stroke speed of the group, then change the ranking to an average split time of the group, then the ranking to change to a total distance traveled by group, and then repeat.

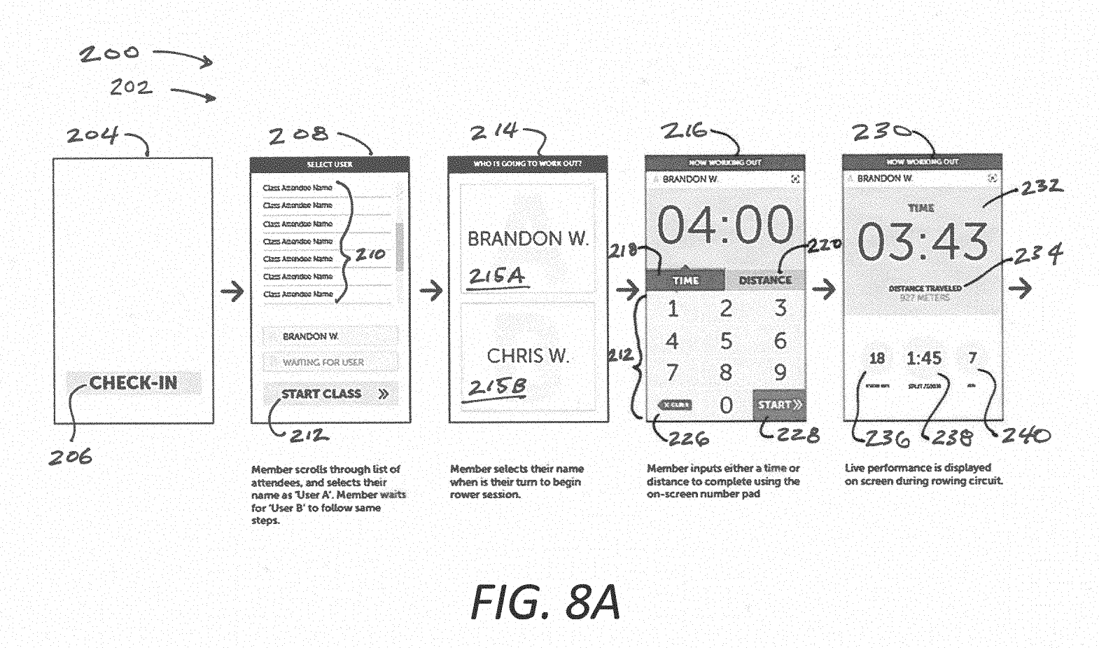

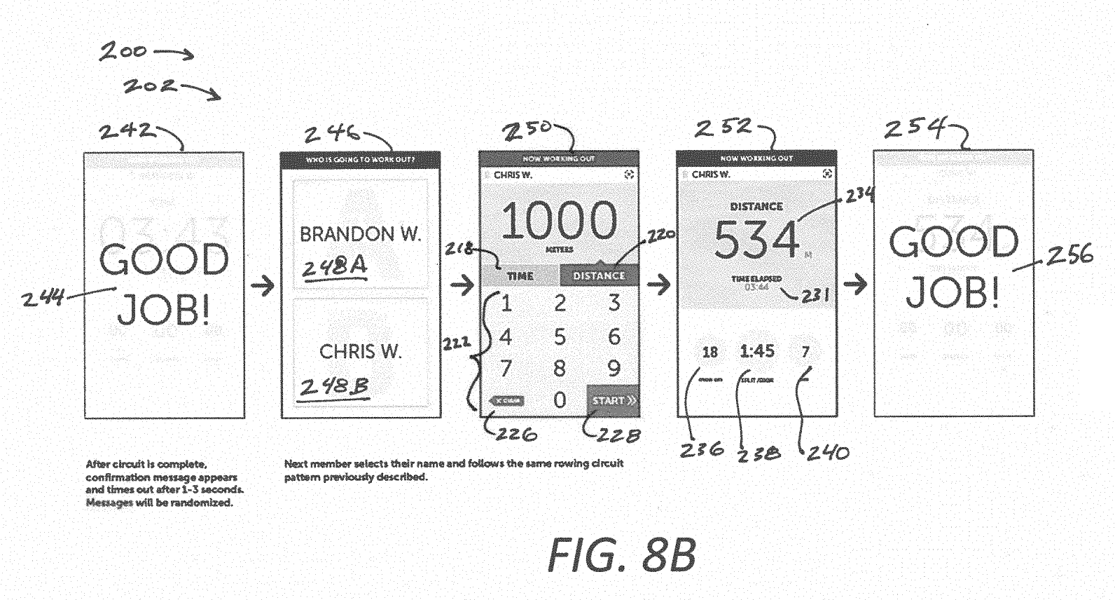

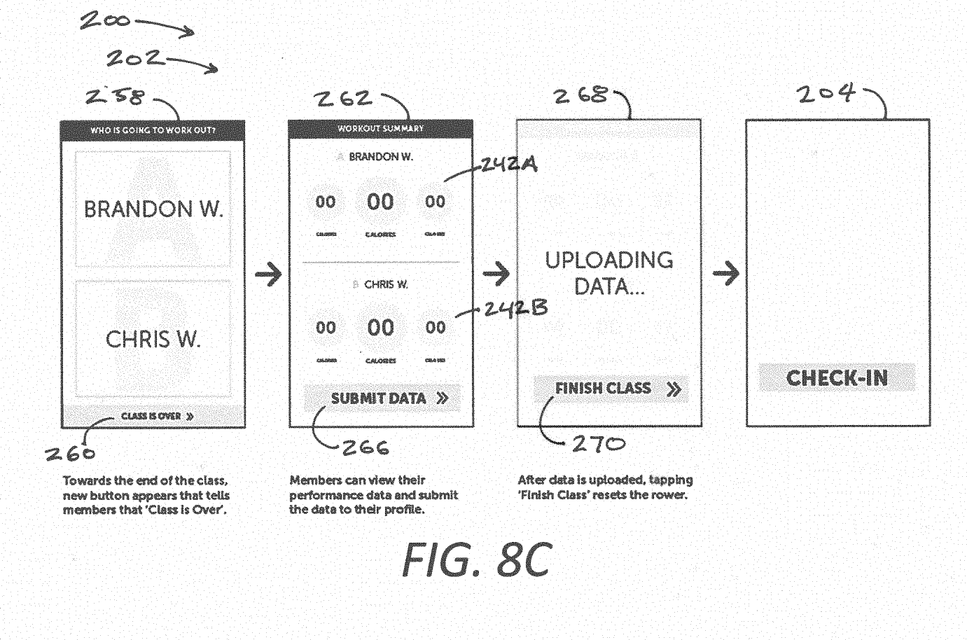

Referring to FIGS. 8A-C, the touch screen interface 200 (shown in FIG. 1), comprises a graphical user interface 202 configured to display a plurality of control screens that a user may enter individual profile and workout preferences. For example, and referring to FIG. 8A, before a class, a first user is presented a check-in screen 204 in which the first user may check into a first exercise device by selecting object 206. The graphical user interface 202 then presents a user selection screen 208 wherein the first user may select their name from a list of users 210, at which time the system 100 waits for a second user to check into a second exercise device connected to the system 100. Once a second user successfully checks into the system 100, the first user may start the class by selecting object 212. The graphical user interface 202 then presents a first confirmation screen 214; wherein the first user confirms their name from a list of users 215A-B checked into the system 100. Once the first user successfully confirms their identity, the graphical user interface presents a first session selection screen 216 wherein the first user may select between a time goal or a distance goal of the session by selecting a time object 218 or a distance object 220 respectively. After selecting either a time goal or distance goal, the first user may enter a number using a virtual number pad 222; wherein the desired time goal or distance goal is displayed in the goal area 224. The first user may edit the number in the goal area 224 by pressing a back icon 226. Once satisfied with the time goal or distance goal, the first user selects a start button 228 to begin the session. The graphical user interface 202 then presents a live performance screen 230 wherein the following data is displayed: time elapsed 231; distance traveled 234; stroke rate 236; split time 236; and miles per hour 240.

After the first session is completed by the first user, the graphical user interface 202 presents a first finish screen 242 where a first message 244 is displayed. The first message 244 is randomized from a list of messages and comprise one of the following messages: “GOOD JOB!,” “CRUSHED IT!,” or other motivational statements. After the graphical user interface displays the first message 244 for a first predetermined amount of time, a second confirmation screen 246 is displayed; wherein the second user confirms their name from a list of users 248-B checked into the system 100. Once the second user successfully confirms their identity, the graphical user interface presents a second session selection screen 250 wherein the second user may select between a time goal or a distance goal of the second session by selecting a time object 218 or a distance object 220 respectively. After selecting either a time goal or distance goal, the second user may enter a number using a virtual number pad 222; wherein the desired time goal or distance goal is displayed in the goal area 224. The second user may edit the number in the goal area 224 by pressing a back icon 226. Once satisfied with the time goal or distance goal, the second user selects a start button 228 to begin the second session. The graphical user interface 202 then presents a live performance screen 252 wherein the following data is displayed: time elapsed 231; distance traveled 234; stroke rate 236; split time 238; and miles per hour 240.

After the second session is completed by the second user, the graphical user interface 202 presents a second finish screen 254 where a second message 256 is displayed. The second message 256 is randomized from a list of messages and comprises one of the following messages: “GOOD JOB!,” “CRUSHED IT!,” or other motivational statements.

After the second message 256 is displayed for a second predetermined amount of time, the graphical user interface displays a finish screen 258 where a finish icon 260 is displayed. In an embodiment of the disclosed subject matter, the finish icon 260 comprises the text string “CLASS IS OVER>>.” If the finish icon 260 is selected, the graphical user interface 202 is configured present a summary screen 262 comprising: a first plurality of performance data 242A associated with the first session; and a second plurality of performance data 242B associated with the second session. In an embodiment of the disclosed subject matter, the first plurality of performance data 242A and the second plurality of performance data comprise one or more of: average stroke rate, average split time, and average speed. It is appreciated that the one or more session performance data comprises performance data associated with a specific exercise device. For example, if the exercise device is a stationary bicycle, then performance data comprises: average rotational speed of the crankshaft; total watts; or total elevation gain. Additionally, if the exercise device comprises a treadmill, then performance data comprises: average pace; average inclination; or total elevation gain.

The summary screen 262 further comprises a submit data icon 266. If the submit data icon 266 is selected, the data associated with the first and second sessions is transmitted to server 114 (shown in FIG. 1) and an upload status screen 268 is displayed. After the data is transmitted to server 114, the user may select a finish icon 270 which resets the graphical user interface 202 and displays the check in screen 204.

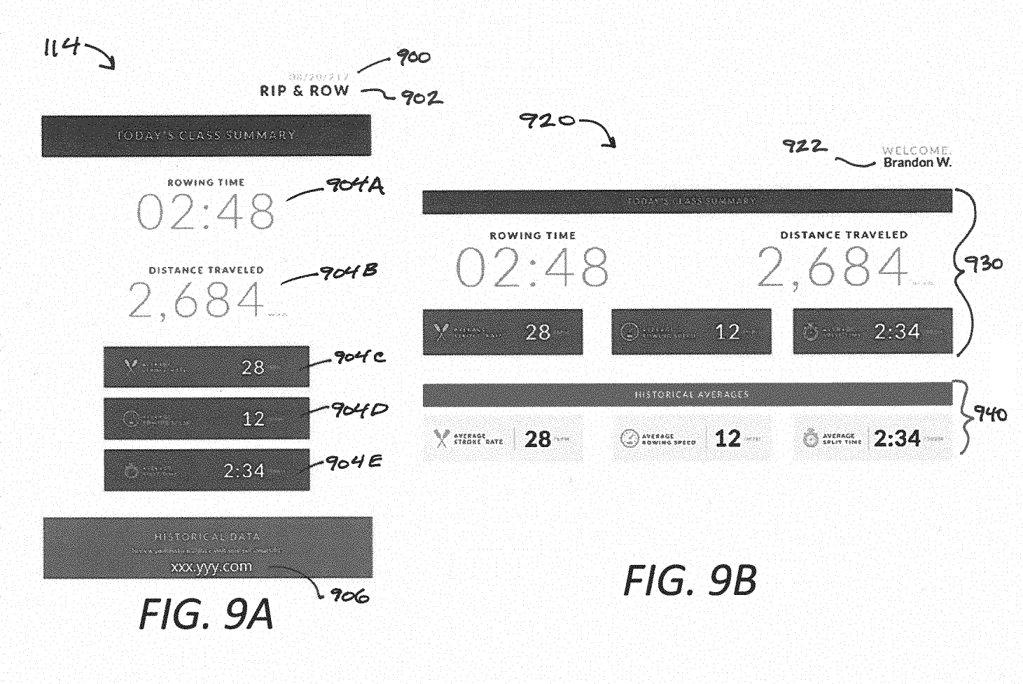

Referring to FIG. 9A, in an embodiment of the disclosed subject matter, after completion of a workout session, an e-mail 115 (shown in FIG. 1) may be transmitted to a user summarizing the last class workout performance. The e-mail 114 comprising a date 900; a session descriptor 902; a plurality of session performance data 904A-E; wherein the plurality of session performance data 904A-E comprises one or more of: time of workout session 904A, distance traveled 904B, an average stroke rate 904C, an average split time 904D, and an average speed 904E; and a URL link 906 associated with a user account.

Referring to FIG. 9B, the URL link 906 of FIG. 9A is associated with a user account may reference webpage 920 comprising a user identifier 922; a workout summary area 930 and a historical average area 940. The workout summary area 930 comprising a plurality of performance data associated with a previous workout session. The historical average area 940 comprising a plurality of historical indices associated with the user.

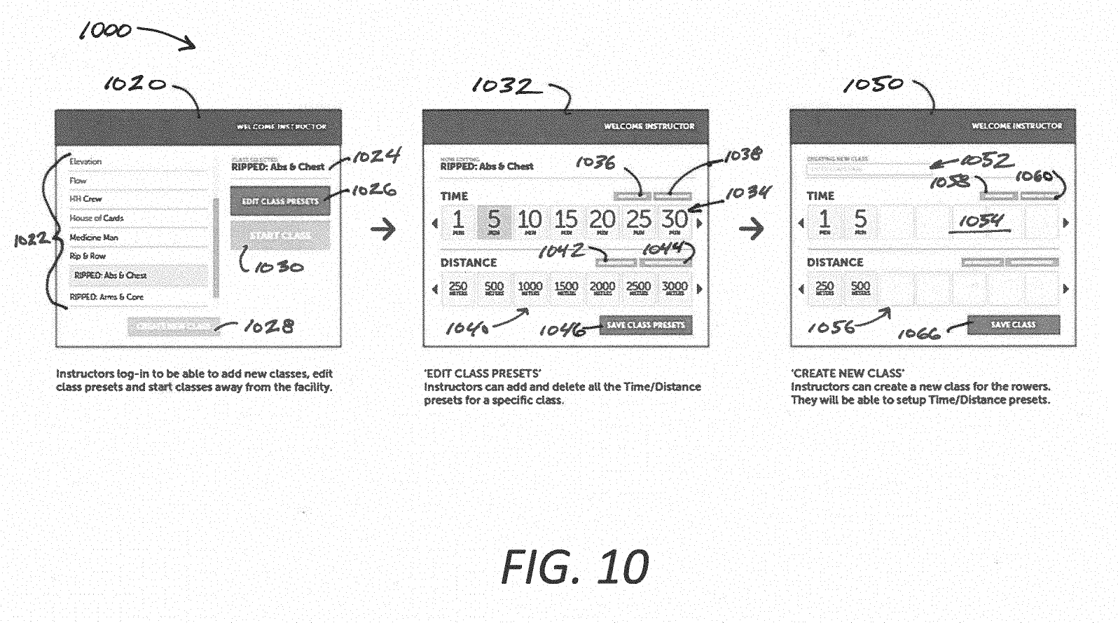

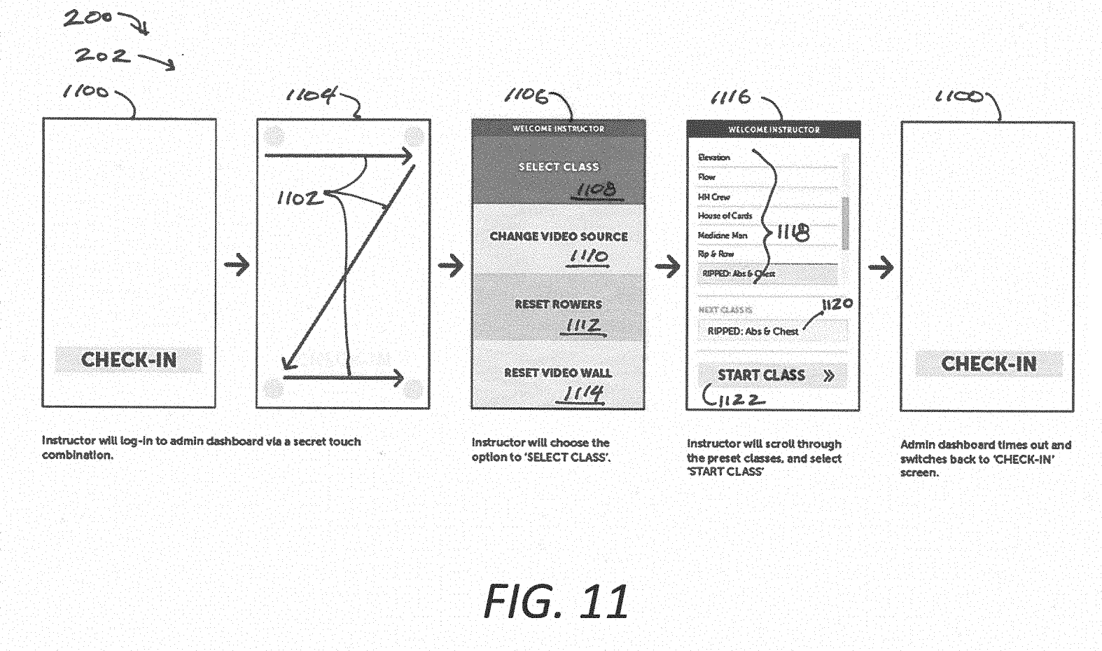

Referring to FIG. 10, the system 100 further comprises an instructor interface 1000 configured to allow an instructor to add a new classes; edit class presets; and start classes away from the facility. The instructor interface comprising a welcome screen 1020; the welcome screen 1020 comprising: a list of classes 1022; a class name area 1024; an edit class preset icon 1026; a create new class icon 1028; and a start class icon 1030. The list of classes 1022 is configured to allow the instructor to select a preconfigured class; wherein the name of the selected preconfigured class is displayed in the class name area 1024. The instructor may edit settings of a class by selecting the edit class preset icon 1026; whereby the instructor interface 1000 presents an edit class presets screen 1032. The instructor may create a new class by selecting the create new class icon 1028; whereby the instructor interface 1000 presents a create new class screen 1050. The instructor may start the preconfigured class displayed in the class name area 1024 by selecting the start class icon 1030.

The edit class presets screen 1032 comprises a plurality of time presets 1034 listed in a sequence. The plurality of time presets 1034 may be added to by selection of the “add time preset” icon 1036. The edit class presets screen 1032 is configured to delete one of the plurality of time presents 1034 by selection of the “remove time present” icon 1038. In a similar manner, the edit class presets screen 1032 is configured to allow the instructor to edit a plurality of distance presets 1040 by providing an “add distance present” icon 1042 and a “remove distance preset” icon 1044. Once the instructor is satisfied with the plurality of time and distance presets, 1034, 1040, the class preferences may be saved by selecting a “save class presets” icon 1046. The instructor interface 1000 will then re-present the welcome screen 1020.

The create new class screen 1050 comprises: a class name field 1052, wherein the instructor may enter a new class name; a plurality of editable time boxes 1054; a plurality of editable distance boxes 1056; and a “save class” icon 1066. The instructor may add time intervals to the plurality of editable time boxes 1054 by selecting an “add time preset” icon 1058. The instructor may additionally remove one of the plurality of editable time boxes 1054 by selecting a “remove time preset” icon 1060. In a similar manner, the instructor may add distance intervals to the plurality of editable distance boxes 1056 by selecting an “add distance preset” icon 1062. The instructor may additionally remove one of the plurality of editable distance boxes 1056 by selecting a “remove time preset” icon 1060. Once satisfied with the plurality of editable time boxes 1054 and the plurality of editable distance boxes 1056, the instructor may save the class presets by selecting the “save class icon 1066, at which time the instructor interface 1000 will re-present the welcome screen 1020 to the instructor.

Referring to FIG. 10, the touch screen interface 200 (shown in FIG. 1), comprises a graphical user interface 202 configured to display a plurality of control screens that an instructor may enter login credentials profile and access class and studio preferences. For example, before a class, the instructor is presented a check-in screen 1100 on which the instructor may enter a secret touch combination by swiping a predetermined pattern 1102 on the screen area 1104 in order to unlock the instructor welcome screen 1106. The instructor welcome screen 1106 comprises: a select class icon 1108; a change video source icon 1110; a reset rower icon 1112; and a reset video wall icon 1114. By selecting the select class icon 1108, a graphical user interface 202 is configured to present an instructor selection screen 1116; whereby the instructor may select a class from a list of classes 1118. The selected class is displayed in a class selection field 1120; and the instructor may started the selected class by selecting the “start class” icon 1122. Once the class is started, the graphical user interface 202 is configured to return to the check-in screen 1100.

The instructor welcome screen 1106 is further configured to: change video sources through the selection of the change video source icon 1110. The instructor welcome screen 1106 is further configured to reset all exercise devices and upload any session data that was not transmitted to the server 114 (shown in FIG. 1) through the selection of the reset rower icon 1112. It is appreciated the disclosed subject matter is not limited just to rowers and the change rower icon 1112 may be configured to change any variation of exercise devices 180 (shown in FIG. 1). The instructor welcome screen 1106 is further configured to clear any information that was displayed on the screen 136 (shown in FIG. 1) through the selection of the reset video wall icon 1114.

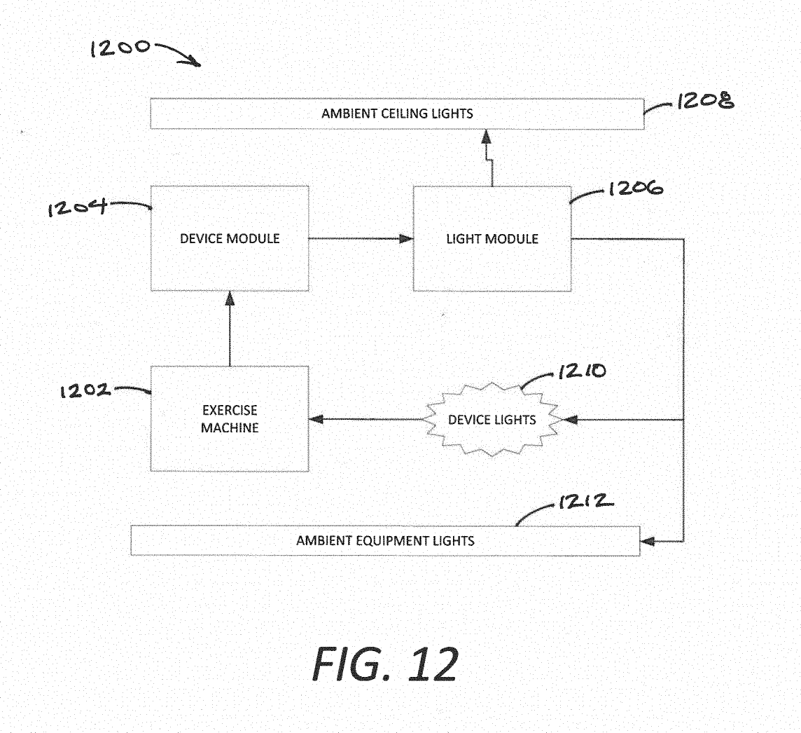

Referring to FIG. 12, a reactive light feedback system 1200 for use with an exercise machine comprising: the exercise machine 1202; an exercise module 1204 configured to continuously monitor a performance metric associated with the use of the exercise machine 1202; a light module 1206 connected to the device module 1204; and a plurality of lights 1208, 1210 and 1212 configured to respond to the light module 1206. In embodiment, the plurality of lights comprising one or more of: ambient ceiling lights 1206 positioned above the exercise machine 1202; device lights 1208 attached to the exercise machine 1202; and ambient equipment lights 1210 configured to illuminate at least parts of the exercise machine.

In another embodiment of the disclosed subject matter, the system 100 may comprise an exercise machine configured to continuously monitor a performance metric associated with the use of the machine; and an indicator responsive to the performance metric; the indicator configured to display a first state indicator if the performance metric is less than a first predetermined value; the indicator configured to display a second state indicator if the performance metric is above the first predetermined value. In another embodiment, wherein the indicator is a light source configured to display the second state indicator if the performance metric is below a second predetermined value; and wherein the light source is configured to display a third state indicator if the performance metric is greater than the second predetermined value.

In another embodiment of the disclosed subject matter, the system 100 may comprise a non-continuous indicator that changes based on at least three potential states. The at least three potential states may comprise: below target; at target; and above target.

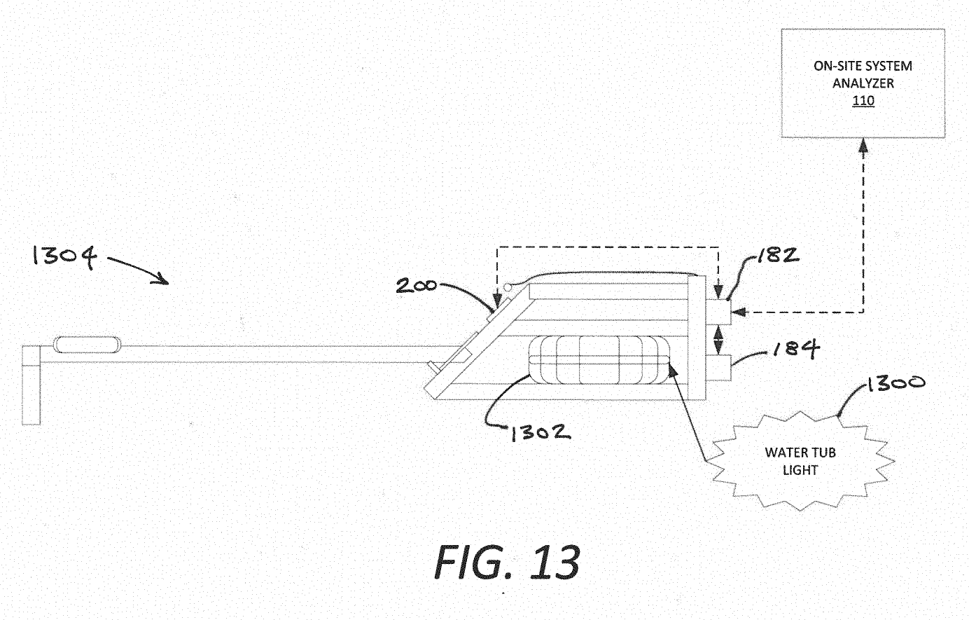

Referring to FIG. 13, the device lights 1208 illustrated in FIG. 12 may further comprise a water tub light 1300 configured to illuminate a water tub 1302 of a stationary rower 1304. The water tub light 1300 may be positioned outside of the water tub 1302, or disposed inside the water tub 1302. The water tub light responsive to a stroke rate of the stationary rower 1304, as monitored by the device module 1204 of FIG. 12.

In an embodiment of the disclosed subject matter, the touch screen interface 200 (of FIG. 1) is connected to the stationary rower 1304. The touch screen interface 200 configured to communicate with the device module 182 (of FIG. 1); wherein the device module 182 is configured to communicate with the on-site system analyzer 110 and device CPU 184 (each of FIG. 1).

Methods of Use

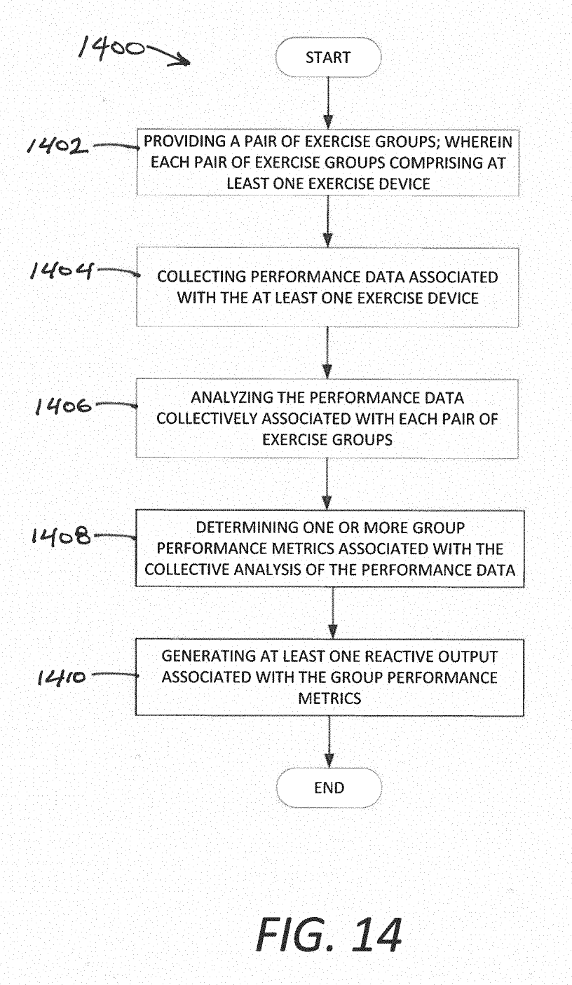

Referring to FIG. 14, in an embodiment of the disclosed subject matter, a method 1400 of providing an interactive exercise system comprising the steps of: providing a pair of exercise groups; wherein each pair of exercise groups comprising at least one exercise device (step 1402); collecting performance data associated with the at least one exercise device (step 1404); analyzing the performance data collectively associated with each pair of exercise groups (step 1406); determining one or more first group performance metrics associated with the collective analysis of the performance data (step 1408); and generating at least one reactive output associated with the one or more first group performance metrics (steps 1410).

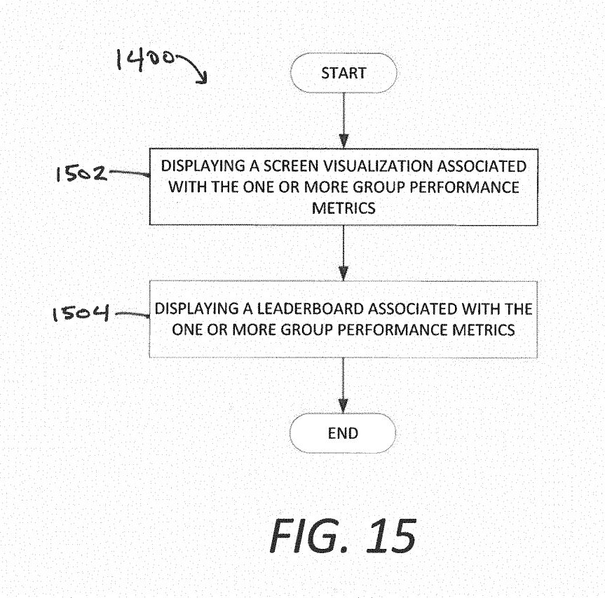

Referring to FIG. 15, the method 1400 of providing an interactive exercise system may further comprise the steps of: displaying a screen visualization associated with the at least one reactive output (step 1502); and displaying a leaderboard associated with the one or more group performance metrics (step 1504).

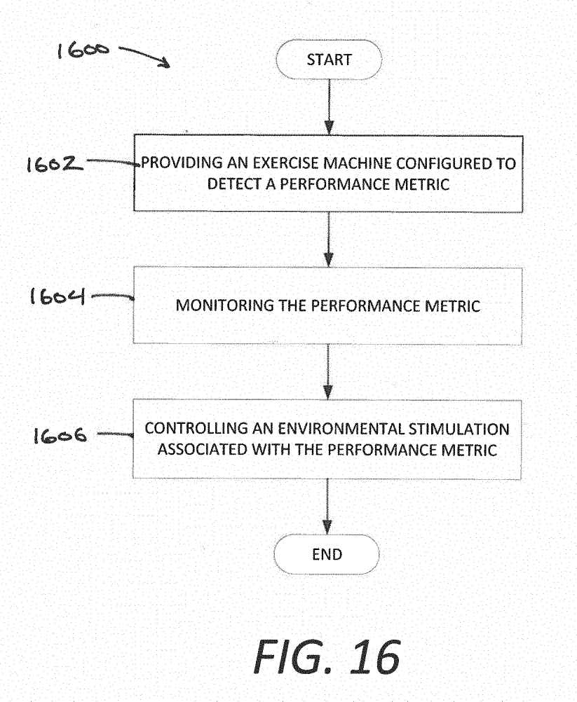

Referring to FIG. 16, in an embodiment of the disclosed subject matter, a method 1600 of providing performance feedback comprising the steps of: providing an exercise machine configured to detect a performance metric (step 1602); monitoring the performance metric (step 1604); and controlling an environmental stimulation associated with the performance metric (step 1606). In a preferred embodiment of method 1600, wherein the performance metric is one or more of: stroke rate; cadence; split time; speed; inclination; and heart rate. In a preferred embodiment of method 1600, wherein the environmental stimulation is a light source configured to illuminate a water tub.

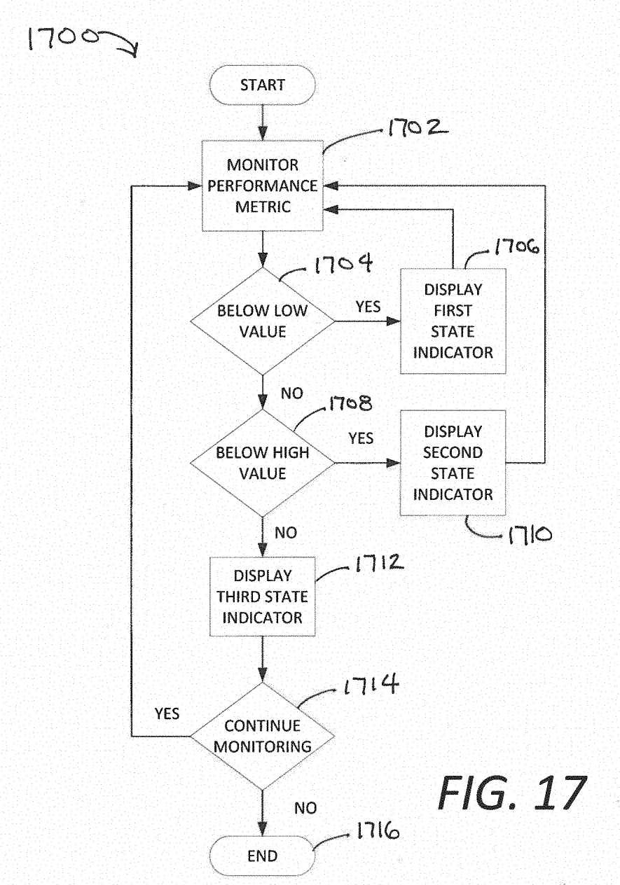

Referring to FIG. 17, a method 1700 for controlling an environmental stimulation associated with the performance metric (step 1606 of method 1600) comprises the steps of: monitoring a performance metric of the exercise device (1702); determining if the performance metric is below a low value (step 1704), and displaying a first state indicator if the value is below the low value (step 1706) and repeating step 1702. If the performance metric is not below the low value, then determining if the performance metric is below a high value (step 1708), and displaying a second state indicator if the performance metric is below the high value (step 1710) and repeating step 1702. If the performance metric is not below the high value, then displaying a third state indicator (step 1712); determining if the performance metric should continue be monitored, if so, then repeating step 1702, if not, then end the method (step 1716). In a preferred embodiment of method 1700, the first state indicator comprises the color black, the second state indicator comprises the color blue, and the third state indicator comprises the color white.

Insofar as the description above and the accompanying drawings disclose any additional subject matter that is not within the scope of the single claim below, the inventions are not dedicated to the public and the right to file one or more applications to claim such additional inventions is reserved.

Having described the disclosed subject matter, what is claimed as new and desired to be secured by Letters Patent is:

1. A system, comprising:
a pair of exercise groups; wherein each exercise group comprising at least one exercise device; and
a system analyzer configured to:
collect performance data associated with the at least one exercise device;
analyze the performance data collectively associated with each exercise group; and
provide at least one reactive output associated with each exercise group based on the analysis of the performance data.

2. The system of claim 1, further comprising a screen visualization associated with the at least one reactive output.

3. The system of claim 2, wherein the screen visualization comprising one or more of:
a dynamic environmental display; and
a leaderboard comprising one or more group performance metrics associated with the analysis of the performance data.

4. The system of claim 3, wherein the dynamic environmental display comprising one or more of:
a plurality of reactive lights;
an abstract visualization;
a simulated water surface;
a simulated road environment;
a simulated trail environment; and
a simulated spatial environment.

5. The system of claim 3, wherein the one or more group performance metrics comprising one or more of:
overall leader;
leader within each of the pair of groups;
leading group of the pair of groups;
distance;
speed;
stroke rate;
revolutions per minute;
elevation gain;
vertical oscillation;
split time;
1-mile split time;
total time;
weight;
watts;
cadence;
heart rate; and
calories burned.

6. The system of claim 1, further comprising an audio device configured to receive the at least one reactive output.

7. The system of claim 1, wherein the at least one exercise device comprising a device module configured to communicate with the system analyzer.

8. The system of claim 7, wherein the at least one exercise device comprising a touch screen interface configured to communicate with the device module.

9. The system of claim 1, wherein the performance data comprises one or more of:
session time;
distance;
speed;
stroke length;
stroke speed;
strokes;
revolutions;
revolutions per minute;
pedal speed;
elevation gain;
vertical oscillation;
inclination;
steps;
step height;
step speed;
step length;
weight;
resistance;
repetitions;
cadence;
watts;
oxygen consumption;
heart rate; and
calories burned.

10. The system of claim 1, wherein the at least one exercise device comprising one or more of:
rowing machine;
spin bicycle;
cross trainer;
elliptical;
treadmill;
climbing wall treadmill;
stair climber; and
resistance trainer.

11. A system, comprising:
a first group of exercise machines;
a second group of exercise machines;
a system analyzer configured to:
collect performance data associated with the first group of exercise machines and the second group of exercise machines;
determine one or more first group performance metrics associated with the performance data of the first group of exercise machines; and
determine one or more second group performance metrics associated with the performance data of the second group of exercise machines;
a dynamic environmental display responsive to the one or more first group performance metrics and the one or more second group performance metrics; and
a leaderboard comparing at least one of the one or more first group performance metrics against at least one of the one or more second group performance metrics.

12. The system of claim 11, wherein the dynamic environmental display comprises a simulated spatial environment.

13. The system of claim 12, wherein each of the first group of exercise machines and the second group of exercise machines comprising at least one rowing machine.

14. An exercise system, comprising:
an exercise machine configured to continuously monitor a performance metric associated with the use of the machine; and
an indicator responsive to the performance metric; the indicator configured to display a first state indicator if the performance metric is less than a first predetermined value; the indicator configured to display a second state indicator if the performance metric is above the first predetermined value.

15. The exercise system of claim 14, wherein the indicator is a light source configured to display the second state indicator if the performance metric is below a second predetermined value; and wherein the light source is configured to display a third state indicator if the performance metric is greater than the second predetermined value.

16. The exercise system of claim 14, wherein the performance metric is one or more of:
stroke rate;
cadence;
split time;
speed;
inclination; and
heart rate.

17. The exercise system of claim 15, wherein the light source is configured to illuminate a water tub.

18. A method of providing an interactive exercise system, comprising the steps of:
providing a pair of exercise groups; wherein each pair of exercise groups comprising at least one exercise device;
collecting performance data associated with the at least one exercise device;
analyzing the performance data collectively associated with each pair of exercise groups;
determining one or more first group performance metrics associated with the collective analysis of the performance data; and
generating at least one reactive output associated with the one or more first group performance metrics.

19. The method of claim 18, further comprising the steps of:
displaying a screen visualization associated with the at least one reactive output; and
displaying a leaderboard associated with the one or more group performance metrics.

20. The method of claim 19, wherein the screen visualization comprises a simulated spatial environment.

21. A method of providing performance feedback comprising the steps of:
providing an exercise machine configured to detect a performance metric;
monitoring the performance metric; and
controlling an environmental stimulation associated with the performance metric.

22. The method of claim 21, wherein the exercise machine comprising a rowing machine; and wherein the performance metric comprising a stroke rate.

23. The method of claim 21, wherein the environmental stimulation comprising one or more of:
a light source;
a ventilation source; and
a sound source.

24. The method of claim 23, wherein the light source configured to illuminate a water tub.

25. An exercise environment, comprising:
an exercise room comprising a pair of exercise groups disposed within the exercise room; wherein each exercise groups comprising at least one stationary rower; the at least one stationary rower comprising:
a device module configured to communicate with a device CPU associated with the at least one stationary rower; and
a touch screen interface configured to communicate with the device module;
a system analyzer configured to:
collect performance data from the device module associated with the at least one stationary rower;
analyze the performance data collectively associated with each exercise group; and
provide at least one reactive output associated with each exercise group based on the analysis of the performance data; and
a screen visualization associated with the at least one reactive output; wherein the screen visualization comprising one or more of:
a simulated water surface; and
a leaderboard comprising one or more group performance metrics associated with the analysis of the performance data.

26. The exercise environment of claim 25; wherein the system analyzer is configured to communicate with a remote system analyzer.
